(19) United States
(12) Patent Application Publication
(10) Pub. No.: US 2007/0147812 A1
(43) Pub. Date: Jun. 28, 2007

(54) Digital panoramic camera

(75) Inventors: Petri Nenonen, Tampere (FI); Mejdi Trimeche, Tampere (FI); Sakari Alenius, Lempaala (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/317,629

(22) Filed: Dec. 22, 2005

(51) Int. Cl. G03B 37/02

(52) U.S. Cl. 396/20

(57) ABSTRACT

The invention relates to the field of image processing and more specifically to image processing in a digital camera for taking panoramic pictures. The digital camera according the invention is adapted to produce an image of a target area when the area is swept by the camera. The camera comprises at least an image sensor comprising several detector lines wherein the image sensor creates picture elements, each of which contains information on one or more detector lines, a control unit that is adapted to control the operation of the camera and to detect the sweeping speed, and a memory for storing picture elements. The camera is adapted to record and store a sequence of picture elements, where the next picture element in the sequence is selected based on sweeping speed, and the camera creates an image from the stored sequence of picture elements.

### BACKGROUND OF THE INVENTION

The present invention relates to the field of image processing and more specifically to image processing in a digital camera for creating panoramic pictures.

Today, panoramic photography is carried out in various ways. One is to use a still camera mounted on a tripod to take a succession of shots as the camera is pivoted around the tripod. In some cameras, a wider than usual strip of film is exposed by means of special movable optics.

Other techniques for creating panoramic photography include physically cutting and pasting together strips of exposed film by carefully aligning boundaries between the edges of film.

The benefits of electronic photography have led to the growth of digital cameras, that, unlike their film-based counterparts, store images captured in memory into digital memory, such as flash memory. To provide panoramic photography effects, these digital cameras can interface with personal computers for joining together two or more images into one image to provide a panoramic effect by joining the edge boundaries of images.

A panoramic camera with a memory device for storing data from a previously photographed portion of an object and a control device for enabling the display device to substantially display both the image to be photographed and the image already photographed and stored in the memory space is described in U.S. Pat. No. 5,138,460.

Although these techniques are useful, they are not without shortcomings. One shortcoming of the current panoramic cameras is how difficult it is to properly overlap a region between two adjacent frames of a panoramic image. Too much overlapping results in wasting memory in the digital camera with redundant information.

### BRIEF SUMMARY OF THE INVENTION

The aim of this invention is to present a new solution for taking panoramic pictures. The invention relates to a digital camera. The invention also relates to a method and a computer program product for creating panoramic pictures.

The digital camera according the invention is adapted to produce an image of a scene, or object when the camera is swept by the user. The camera comprises at least an image sensor comprising several detector lines and a line of detectors wherein the image sensor creates picture elements, each of which contains information on one or more detectors, a control unit that is adapted to control the operation of the camera and to detect the sweeping speed, and a memory for storing picture elements. The camera is adapted to record and store a sequence of picture elements, where the next picture element in the sequence is selected based on sweeping speed. The camera creates an image from the stored sequence of picture elements.

As used herein, picture element can be for example one or more vertical lines of detectors extending e.g. from a top edge to a bottom edge of the image sensor and which are useful for sweeping a scene with the camera moving panoramically in a horizontal direction. Similarly, a picture element can be for example one or more horizontal lines extending from a left edge to a right edge of the image sensor and useful for sweeping a scene panoramically in a vertical direction. thus, while the term “picture element” as used herein could conceivably embrace just a single light detector it is most advantageously used to embrace one or more lines of such detectors, as will become more apparent below.

The method comprises recording a sequence of picture elements created by an image sensor of the camera, selecting the next picture element to be stored in the memory based on sweeping speed, and creating an image from the stored sequence of picture elements.

The computer program product comprises instructions for recording a sequence of picture elements created by an image sensor of the camera, selecting the next picture element to be stored in the memory based on sweeping speed, and creating an image from the stored sequence of picture elements. The computer program product, stored in a computer-readable medium and executable in a data processing device, is suitable, for example, for creating a panoramic image by using a digital camera.

In principle, the term sweeping in this application means that the picture sensed by an image sensor element is moving. The sweeping motion can be affected in many different ways. The implementation can also be made off-line, so that a pre-recorded video clip containing panoramic movement is processed, as if it were a viewfinder data-stream.

By combining, in various ways, the modes and structures disclosed in connection with the different embodiments of the invention, it is possible to produce various embodiments of the invention in accordance with the spirit of the invention.

In one embodiment the user rotates the camera to scan the scene, and picture elements comprising vertical lines from the center of the sensor are recorded and combined progressively to form a panoramic image. The panoramic image is created by compensating for the speed of the manual scanning.

In one embodiment the middle detector line of the sensor is adapted to record. In other words, the middle detector line is used for recording as the camera is swept panoramically and the other lines are not used.

In one embodiment one or a few vertical lines (or horizontal lines in case of vertical panorama) at the center of the images are used to form cylindrical panoramic projection as in a conventional analog panoramic line camera.

In one embodiment the control unit is adapted to detect the sweeping speed by using the data produced by the image sensor.

In one embodiment the control unit is adapted to detect the sweeping speed by using the data produced by all the detectors of the image sensor.

In one embodiment data obtained from the entire camera sensor is used for motion estimation and for getting information beyond the recorded lines. Motion estimation is used for merging the lines in the correct location in the final panoramic image. When the camera moves left or right (or up/down) the new data in the recorded lines is inserted into the panoramic image. The motion estimation is also used to remove unwanted (e.g. not vertical) rotation of the camera.

In one embodiment the detector line that is adapted to produce a picture element is arranged perpendicularly to the sweeping direction.

In one embodiment the width of the detector line that is adapted to produce a picture element is adjusted to depend on the sweeping speed.

In one embodiment, in order to capture an image of an object, e. g. a scene or a building facade, the user scans the object with a single sweep of the camera while the camera is taking the picture. The camera stitches the picture elements so as to create a panorama or mosaic picture.

In one embodiment the next picture element to be stored in the memory is arranged to partly overlap with a picture element that is already stored in the memory.

In one embodiment the next picture element in the sequence to be stored in the memory is arranged side by side with a picture element that is already stored in the memory.

It is possible to use the present invention in many solutions. In some solutions the device is a typical digital camera and in some solutions the camera unit is integrated to other units. For example, the device could be a mobile phone, a computer, a game device, a communication device, etc.

An advantage of the method and device of the invention is that the user may rotate the camera freely. No camera stand is required. This makes a very compact mobile implementation possible, i.e. the system may be implemented easily into mobile camera phones.

In addition, the different solutions offer many other advantages. For example, a given solution can offer one or more of the following advantages:
One embodiment provides a cylindrical panoramic projection with perfect image stitching and seamless exposure as the rotating film camera. There is no need to compensate for optical aberrations on the corners of the image.
The system can be implemented with any standard digital camera module.
It is possible to create interesting and amusing effects when the user is allowed to move the camera freely while the scan lines are recorded.
When recording the exposed scan lines, the full area from the camera sensor, or part of it can be used for adjusting the operations of exposure control, AWB and motion estimation/compensation.
The dataflow from the sensor is low, because only a few high-resolution lines need to be captured at each time instance. The motion estimation can be made from a reduced size viewfinder image.
It is possible to compensate distortions typical of moving objects in panoramic film cameras.
Extended depth of focus can be achieved when the focus is changed during the scanning of the object.

### BRIEF DESCRIPTION OF THE DRAWINGS

In the following, the invention will be described in more detail with reference to the appended principle drawings, in which

FIG. 1 shows a device according to one embodiment;

FIG. 2 shows a block diagram of a device according to one embodiment;

FIG. 3 shows a flow diagram of an example;

FIG. 4 shows an example of a scene;

FIG. 5 shows an example of a viewfinder area;

FIG. 6 shows an example of an unfinished image;

FIG. 7 shows an example of the composition of an image using sub-pixel displacements;

FIG. 8 shows an example of compensation of horizontal rotation;

FIG. 9 shows an example of pre-capture line information;

FIG. 10 illustrates a simplified implementation alternative.

For the sake of clarity, the figures only show the details necessary for understanding the invention. The structures and details which are not necessary for understanding the invention and which will be evident for anyone skilled in the art have been omitted from the figures in order to emphasize the characteristics of the invention.

### DETAILED DESCRIPTION OF THE INVENTION

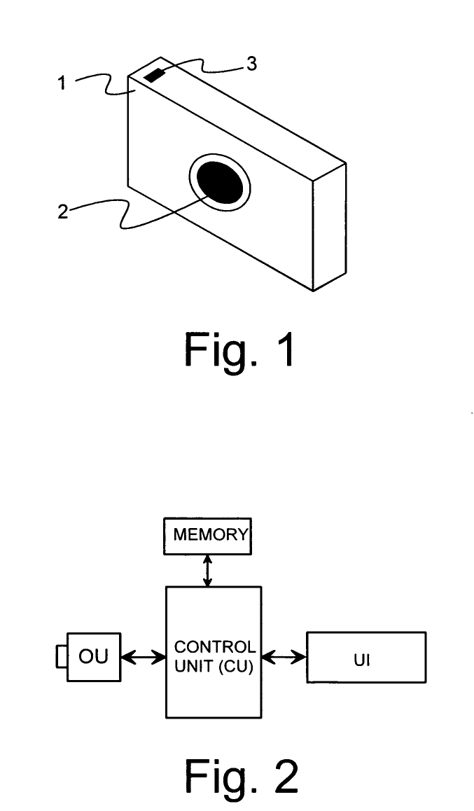

FIG. 1 shows one example of a digital camera. In this example is shown a housing 1, a trigger button 3, and a lens arrangement 2. It is possible to use the present invention in many solutions. In some solutions the device is a typical digital camera and in some solutions the camera unit is integrated with other units. For example, the device could be a mobile phone, a computer, a game device, a communication device, etc.

FIG. 2 shows a block diagram of a device according to the present invention. The device comprises at least an optical unit OU, a control unit CU, a memory unit MEMORY and a user interface UI. The optical unit OU typically comprises some kind of a lens arrangement and an image sensor (described hereinafter as simply a sensor) component, such as a CCD or a CMOS-component. Usually the sensor component comprises a detector matrix. In the detector matrix there are several detector rows and detector columns (in other words, detector lines).

The control unit CU is, in turn, arranged to control the function of the camera. The user interface UI comprises at least one display. Different kinds of information is shown on the display. Usually the display is also used as a viewfinder.

The memory unit is arranged to store the pictures. The memory unit can be, for example, a fixed unit, a removable unit or some kind of a combination of fixed and removable units. Usually some kind of removable memory cards are used.

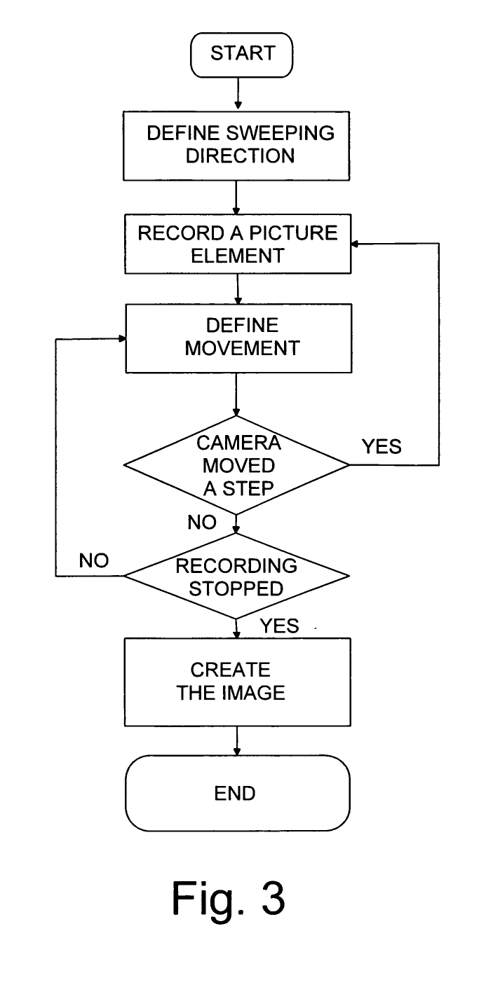

FIG. 3 shows a simple flow diagram of one embodiment. First, the recording starts, for example, when the user pushes the trigger button 3 of a camera. The system detects the direction and the speed of motion (sweeping direction and speed). The system senses and records picture elements. One detector line or a plurality of adjacent detector lines can be used as a “picture element,” according to the present invention, for forming a panoramic image when sweeping a scene panoramically. The first picture element is stored in the memory. Next, the picture elements to be stored in the memory are selected based on sweeping speed. The camera processes the picture elements stored in the memory to create a image. The recording stops, for example, when the trigger button 3 is released.

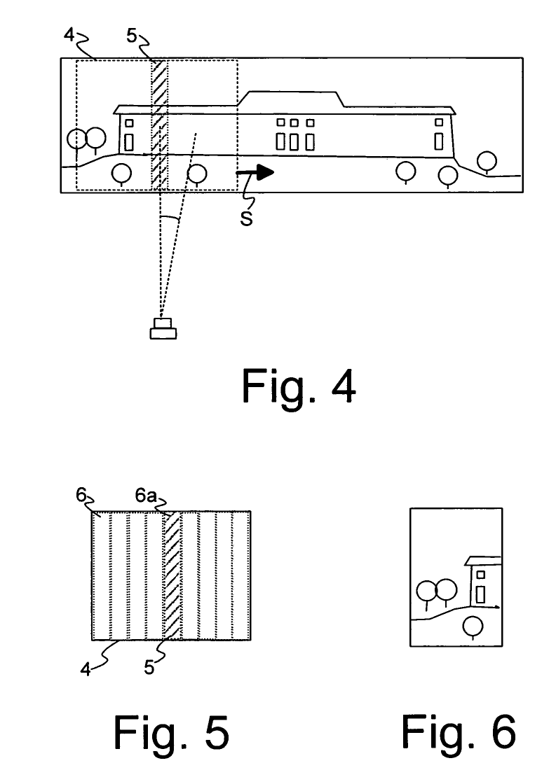

In the following, the operation of the camera will be described by means of a simplified use case. In this case a user wants to take a picture of a scene that is so large that it is partly out of the viewfinder area 4, as shown in FIG. 4. In FIG. 5 the viewfinder area 4 is described in more detail. A viewfinder area 4 and the middle area 5 of the viewfinder area are shown. The viewfinder area 4 comprises several vertical detector lines 6. Usually there are hundreds or thousands of detector lines 6, but in the figures, less detector lines are shown in a bigger scale in order to emphasize the characteristics of the embodiments. The middle area 5 comprises a line of detectors 6a that is adapted to produce a picture element. In the embodiment shown, the surrounding lines are not used, i.e., the line or lines 6a are used to the exclusion of the lines in the surrounding areas to the left and right of area 5. The middle area 5 that is adapted to produce a picture element is arranged perpendicularly to the sweeping direction S. The middle area 5 is in FIG. 4 in a vertical position because the sweeping direction S is essentially horizontal. In a case where the sweeping direction S is essentially vertical, the middle area 5 is horizontal.

The user starts sweeping the scene manually, for example by pushing the trigger button 3 and moving the camera. The sweeping motion can be effected in many different ways and it can be, for example, a rotating or a linear motion.

In one embodiment the sweeping speed and direction S of the camera is estimated from the viewfinder data. In one embodiment the estimation of the sweeping speed and direction S is pixel-based. When the middle area 5 is moved at least one line 6 in the desired sweeping direction S, the lines 6a of the middle area are captured and merged to the final image. The concept is shown in FIG. 4 and FIG. 6. FIG. 6 shows an unfinished image during the sweeping process. The image shown in FIG. 6 is the image where the picture element produced by the detector line 6a of FIG. 4 is added.

In real-time, the viewfinder of the camera may progressively show the parts of the scene that have been already created, until the entire image is captured.

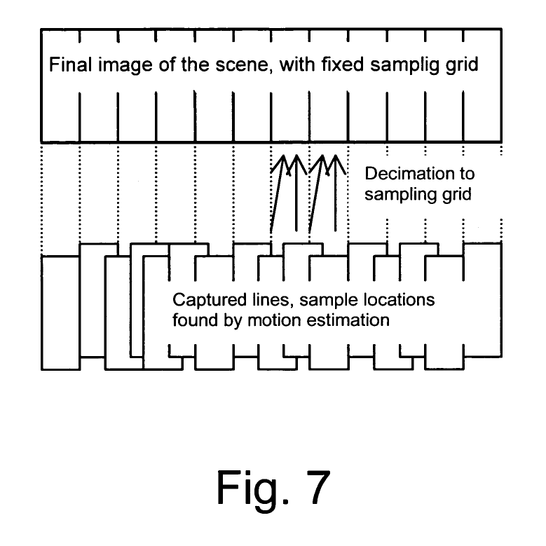

The recordable picture elements can be captured at a higher resolution than the viewfinder data used for motion estimation. The dataflow from the sensor is still low compared to capturing the whole image with full resolution. Because the captured picture elements can be fetched also from sub-pixel locations, i.e. the picture elements are partially overlapping, the spatial sampling grid of the captured picture elements can be denser than the sampling grid of the final image, as shown in FIG. 7. Therefore, decimation to the final sampling grid is required. Super resolution techniques can also be used for obtaining an increased resolution image. In one embodiment, if the captured picture element contains the same data as the already stored picture element, the captured picture element can be discarded, if super resolution is not used. This situation can exist, for example, when there is a low sweeping speed or no motion at all.

The free camera movements may also include translational motion, which means that motion may be different for objects that are close by than for objects that are far. In one embodiment the motion estimation may be implemented so that if a large enough part of the scene at the captured picture element is moving by one line, the captured area is merged to the image.

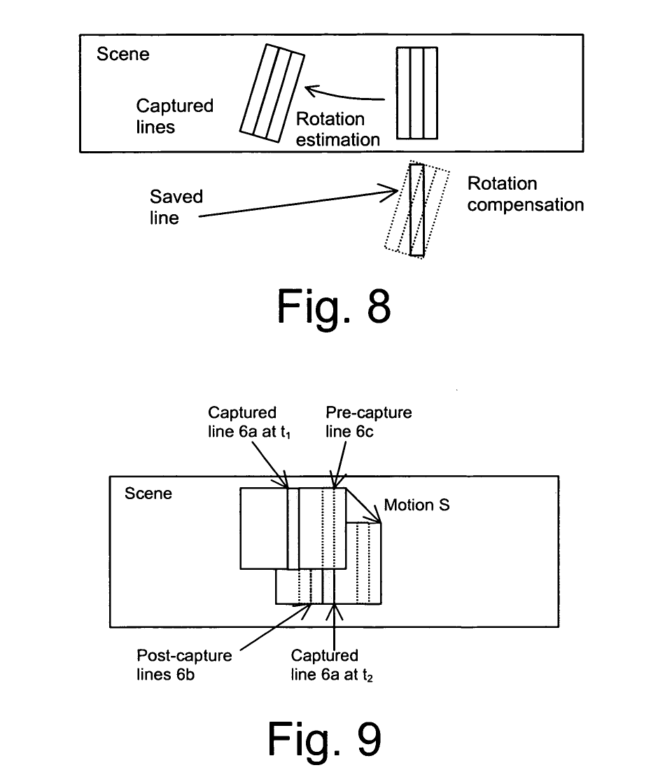

Because horizontal rotation (about the optical axis) of the camera may also exist, the captured picture elements may be rotated with respect to each other. In one embodiment, in order to compensate this, a few vertical lines in the middle of the images may be captured and the motion estimation and compensation may be used to compensate the rotational movement as shown in FIG. 8. In one embodiment the rotation compensation can also be relaxed. In this case it is possible to form different kinds of bent images.

If the sweeping speed is fast compared to the frame rate, so that the captured picture element has moved more than the width of one line, one captured line/frame is not necessarily enough. In one embodiment several detector lines 6a, 6b may be recorded. For example, all lines (post-capture picture elements 6b) between the capturing lines 6a, 6b are recorded. This situation can be seen in FIG. 9. If the frame rate is so low that no frames are available between t₁ and t₂, all lines between lines 6a, 6b captured at t₁ and t₂ are also recorded and merged to the image. In one embodiment a picture element contains data from several detector lines. In another embodiment there are several picture elements, each of which has produced a detector line, which detector lines are side by side. Because the low sampling rate equals to sparser spatial sampling grid than used in the final image, interpolation techniques can also be used, but then the quality of the result is decreased.

In one embodiment the color, contrast and brightness of adjacent lines are automatically matched because the exposure changes smoothly when the camera is moved (for example rotated) and aimed at different locations in the scene. This eliminates the need to compensate for different exposure and AWB settings, as is the case with traditional stitching. Additionally, the exposure settings can be adjusted according to spatial and temporal differences. The whole sensor area 4 can be used for getting the data for the adjustment. For example, the lines 6c in the sweeping direction can be used to predict the exposure setting for the forthcoming lines. The concept of pre-capture lines 6c is depicted in FIG. 9.

In one embodiment the pre-capture data can be used to assist in correcting the errors due to moving objects. Because the actual recording lines 6a capture the image at different time, the comparison between the recording areas reveal moving objects. In traditional rotating panoramic film cameras the moving objects may be captured distorted and bent.

The different embodiments can operate in either vertical or horizontal directions. If vertical panorama is needed, the operation is the same, but the horizontal measuring line or lines progress vertically. The mode may be selected by UI/buttons or automatically based on the direction of the initial movement.

In one embodiment the motion estimation can detect changes in the sweeping (for example rotation) direction S. If same area of the scene is re-swept, the data can be discarded or used for increasing the resolution. If new areas appear, those are inserted into the image. This makes the left-center-right, right-center-left, center-left-(center)-right and center-right-(center)-left sweeping order possible, and corresponding behavior in vertical dimension.

In one embodiment the focus setting or the zoom position (focal length) of the lens can be changed when the sweeping proceeds, which provides extra effects. For instance, extended depth of focus can be achieved when the focus is changed according to the distance of the object. Then, both short-distance and long-distance areas of the object can appear sharper than panoramas made from multiple images. The focus adjustment can be made using any auto focus system. If the focal length is changed (zooming), the effect is more artistic, but unique to this invention.

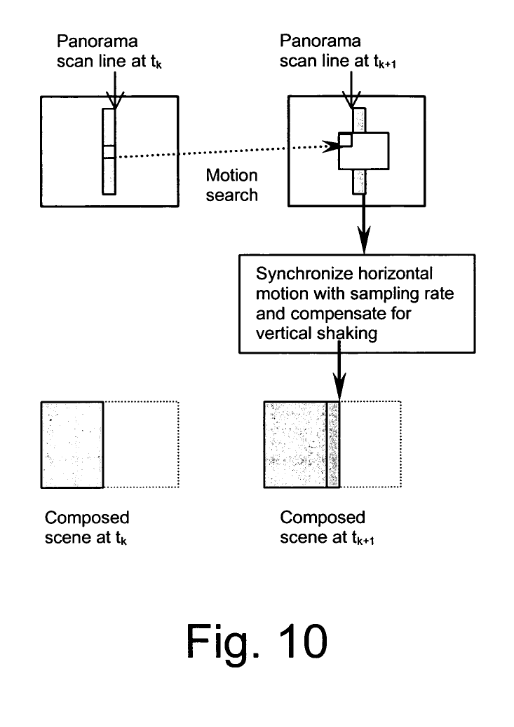

The different embodiments can be implemented into many digital camera devices. FIG. 10 briefly describes a simplified implementation alternative that can be used to realize real-time panorama sweeping. The implementation can also be made off-line, so that a pre-recorded video clip containing panoramic movement is processed, as if it were a viewfinder data-stream.

As discussed above, there are different alternatives to implement the synchronization of the frame rate with the hand motion (i.e. capturing all required lines to cover the amount of the motion and handling the sub-pixel shifts). As the sensitivity of the sensor component is expected to improve, it will be possible to reduce the exposure times and to increase the frame rate, thus enabling faster sweeping of the scene. It will also be possible to record more redundant detector lines, which can be used to improve the performance of the motion estimation and the spatial resolution of the final image.

The speed of hand motion can be guided by various user-interface means and implementations. For example, the UI can show markers, such as arrows, for informing the user whether the speed is correct, too low or too high. The composed image can also be moved with some predetermined speed and mixed with the viewfinder data so that the user tries to keep them aligned, which causes the camera movement with optimal speed.

In one embodiment the camera may be used in conjunction with a cheap motor that rotates the camera. The motion compensation eliminates the need for the mechanical precision traditionally required to achieve the desired result.

By combining, in various ways, the modes and structures disclosed in connection with the different embodiments of the invention presented above, it is possible to produce various embodiments of the invention in accordance with the spirit of the invention. Therefore, the above-presented examples must not be interpreted as restrictive to the invention, but the embodiments of the invention may be freely varied within the scope of the inventive features presented in the claims hereinbelow.

1. A digital camera for producing an image of a target area when the area is swept by the camera, the camera comprising at least
an image sensor comprising several detector lines wherein the image sensor creates picture elements, each of which contains information on one or more detector lines;
a control unit that is adapted to control the operation of the camera and to detect a sweeping speed;
a memory for storing picture elements;
wherein the camera is adapted to record and store a sequence of picture elements, where a next picture element in the sequence is selected based on the sweeping speed, and the camera creates the image from the stored sequence of picture elements.

2. The digital camera according to claim 1, wherein a middle detector line of the image sensor is adapted to record.

3. The digital camera according to claim 1, wherein the control unit is adapted to detect the sweeping speed by using data produced by the image sensor.

4. The digital camera according to claim 1, wherein the control unit is adapted to detect the sweeping speed by using data produced by detectors of the image sensor comprising all said detectors.

5. The digital camera according to claim 1, wherein a detector line adapted to produce a picture element is arranged perpendicularly to the sweeping direction.

6. The digital camera according to claim 1, wherein a width of a detector line adapted to produce a picture element is adjusted to depend on the sweeping speed.

7. The digital camera according to claim 1, wherein the next picture element to be stored in the memory is arranged to partly overlap with a picture element that is already stored in the memory.

8. The digital camera according to claim 1, wherein the next picture element in the sequence to be stored in the memory is arranged side by side with a picture element that is already stored in the memory.

9. The digital camera according to claim 1, wherein the camera is a part of a device, which is at least one of the following: a mobile phone, a computer, a game device.

10. A method for creating a panoramic image by using a digital camera, the method comprising
recording a sequence of picture elements created by an image sensor of the camera,
selecting a next picture element to be stored in a memory based on sweeping speed, and
creating an image from the stored sequence of picture elements.

11. The method according to claim 10, wherein the digital camera comprises at least an image sensor comprising several detector lines wherein a middle detector line of the image sensor is recorded.

12. The method according to claim 10, wherein the control unit detects the sweeping speed by using data produced by the image sensor.

13. The method according to claim 10, wherein the image sensor comprises a plurality of detectors and the control unit detects the sweeping speed by using data produced by all of the plurality of detectors of the image sensor.

14. The method according to claim 10, wherein a detector line comprising a plurality of detectors in a line produces a picture element that is arranged perpendicularly to the sweeping direction.

15. The method according to claim 14, wherein a width of the detector line is adapted to produce a picture element that depends on the sweeping speed.

16. The method according to claim 10, wherein the next picture element to be stored in the memory is arranged to partly overlap with a picture element that is already stored in the memory.

17. The method according to claim 10, wherein the next picture element in the sequence to be stored in the memory is arranged side by side with a picture element that is already stored in the memory.

18. A computer program product, stored in a computer-readable medium and executable in a data processing device, for creating a panoramic image by using a digital camera, the computer program product comprising instructions for
recording a sequence of picture elements created by an image sensor of the camera,
selecting a next picture element to be stored in the memory based on sweeping speed, and
creating an image from the stored sequence of picture elements.
